(19) United States
(12) Patent Application Publication
(10) Pub. No.: US 2017/0328199 A1
(43) Pub. Date: Nov. 16, 2017

(54) MUD PULSE TELEMETRY DEMODULATION USING A PUMP NOISE ESTIMATE OBTAINED FROM ACOUSTIC OR VIBRATION DATA

(71) Applicant: HALLIBURTON ENERGY SERVICES, INC., Houston, TX (US)

(72) Inventor: Laban M. Marsh, Houston, TX (US)

(73) Assignee: HALLIBURTON ENERGY SERVICES, INC., Houston, TX (US)

(21) Appl. No.: 15/531,705

(22) PCT Filed: Dec. 31, 2014
(86) PCT No.: PCT/US2014/073063

§ 371 Date: May 30, 2017

(51) Int. Cl. E21B 47/18; G01V 1/40; E21B 47/06; F04B 51/00; F04B 47/02

(52) U.S. Cl. CPC E21B 47/18; F04B 51/00; G01V 1/40; F04B 47/02; E21B 47/06; E21B 47/182; E21B 47/185; E21B 47/187

(57) ABSTRACT

An example mud pulse telemetry method includes positioning an external acoustic or vibration sensor on or near a pump to collect acoustic or vibration data during operation of the pump. The method also includes monitoring a pressure of fluid in a tubular, the fluid conveying a data stream as a series of pressure variations. The method also comprises processing the monitored pressure to demodulate the data stream. The processing uses a pump noise estimate obtained at least in part from analysis of the acoustic or vibration data.

### BACKGROUND

In most drilling operations, a circulation pump circulates fluid through a drill string and out the drill bit into a borehole. This fluid (often called “mud” in the oilfield industry) may include water and/or oil and additional additives that may be inert or chemically reactive with other molecular compositions present within a borehole during drilling operations. There are a multitude of motivations for pumping mud with one example being simply to remove earth materials from the borehole.

In Mud Pulse Telemetry (MPT), a measurement-while-drilling (MWD) service company (e.g. Halliburton Energy Services, Inc.) may install at least one transducer/sensor within the surface rig's plumbing system. The surface rig's plumbing system mechanically connects the circulation pump(s) (also known as “mud pumps”) with the drill string, which in turns couples with a drill-bit within the borehole. MPT systems employ a downhole “pulser” located near the drill bit to transmit a series of modulated pressure waves through the mud column within a drill string to communicate real-time information to the surface transducers/sensors. However, the surface transducers may be unable to acquire the encoded pulse waveforms due to various forms of attenuation and interference. For example, the circulation pump hinders the operation of the MPT system through the introduction of pump noise. One attempted solution employs pump dampeners (sometimes called “de-surgers”) to buffer the fluid itself, but these are usually unable to prevent the pump noise from being the main source of noise and the main limitation on MPT performance.

### BRIEF DESCRIPTION OF THE DRAWINGS

Accordingly, there are disclosed in the drawings and detailed description specific embodiments of methods and systems for mud pulse telemetry demodulation using a pump noise estimate obtained at least in part from acoustic or vibration data. In the drawings:

FIG. 1 is a schematic diagram showing an illustrative mud pulse telemetry (MPT) environment.

FIGS. 2A and 2B are views showing an illustrative pump in relation to an acoustic or vibration sensor.

FIG. 3A is a diagram showing an illustrative vibration sensor.

FIG. 3B is a diagram showing an illustrative acoustic sensor.

FIG. 4 is a block diagram showing an illustrative computer system.

FIGS. 5A-5D are schematic views showing illustrative pulsers.

FIG. 6 is a block diagram showing an illustrative MPT process.

FIG. 7 is a diagram showing an illustrative process for obtaining and using a pump noise estimate.

FIG. 8A is a graph showing an illustrative pressure signal.

FIG. 8B is a graph showing an illustrative pump noise estimate.

FIG. 8C is a graph showing an illustrative difference between the pressure signal and the pump noise estimate.

FIG. 9 is a flowchart showing an illustrative acoustic or vibration data analysis method.

FIG. 10 is a flowchart showing an illustrative MPT method.

It should be understood, however, that the specific embodiments given in the drawings and detailed description do not limit the disclosure. On the contrary, they provide the foundation for one of ordinary skill to discern the alternative forms, equivalents, and modifications that are encompassed in the scope of the appended claims.

### DETAILED DESCRIPTION

The disclosed methods and systems are directed to mud pulse telemetry (MPT), where data streams are conveyed uphole or downhole by modulating pressure of a fluid in a tubular. As the pressure of fluid in a tubular is a function of a pump's operation (“pump noise”) as well as any MPT operations, demodulating a data stream from pressure variations of fluid in a tubular involves distinguishing between pressure variations that are part of a data stream and pressure variations that are due to pump noise. As used herein, “pump noise” refers to pressure variations of fluid in a tubular that are due to pump operations. Such pump noise interferes with interpreting a data stream modulated as pressure variations of fluid in a tubular.

In at least some embodiments, an example MPT method includes positioning an external acoustic or vibration sensor on or near a pump to collect acoustic or vibration data during operation of the pump. The method also includes monitoring a pressure of fluid in a tubular, the fluid conveying a data stream as a series of pressure variations. The method also includes processing the monitored pressure to demodulate the data stream. The processing uses a pump noise estimate obtained at least in part from analysis of the acoustic or vibration data.

In at least some embodiments, an example MPT system includes one or more transducers that convert a pressure of fluid in a tubular (or some function thereof) to at least one electrical signal, the fluid conveying a data stream as modulated pressure variations. The system also includes an external acoustic or vibration sensor positioned on or near a pump to collect acoustic or vibration data during operation of the pump. The system also includes a processor that demodulates the data stream from the at least one electrical signal using a pump noise estimate obtained at least in part from analysis of the acoustic or vibration data.

In accordance with at least some embodiments, an acoustic sensor or vibration sensor is positioned near a pump sound or vibration source to obtain the acoustic or vibration data indicative of the pump's operation. For example, an accelerometer may be externally mounted or fastened to a pump housing to collect vibration data. Alternatively, a microphone may be externally mounted or fastened to a pump housing to collect acoustic data. In some embodiments, mounting or fastening an acoustic or vibration sensor to a pump housing corresponds to a temporary condition (e.g., using a C-clamp, a strap, a magnet, a band, or another temporary mounting mechanism) due to pump equipment ownership/modification issues.

In at least some embodiments, the collected acoustic or vibration data is analyzed to determine data periodicity. For example, a time-domain signal analysis (e.g., auto-correlation) may be performed to determine data periodicity. As another example, frequency-domain signal analysis (e.g., a Fourier transform) may be performed to determined data periodicity. The data periodicity is used to identify a pump signature within the acoustic or vibration data. As desired, the pump signature is applied to subsequently obtained acoustic or vibration data to determine a pump stroke estimate or related parameters (pump stroke timing information). The pump noise estimate obtained at least in part from analysis of acoustic or vibration data is used to demodulate a data stream conveyed as pressure variations of fluid in a tubular.

In an example demodulation process, pump noise is estimated using pump stroke timing information or other pump noise timing parameters obtained from acoustic or vibration data. The pump noise estimate is subtracted from (or otherwise used to filter) a pressure signal that includes pressure variations due to pump noise and an MPT data stream, such that recovery of the MPT data stream is facilitated.

The following description relates to a variety of MPT methods and systems that enable Measurement-While-Drilling (MWD) or Logging-While-Drilling (LWD) services with real-time data transfer from sensors or survey tools in a bottomhole assembly (BHA) to a surface location. While the MPT demodulation concepts described herein focus on surface components, it should be appreciated that such MPT demodulation may applied to downhole systems as well.

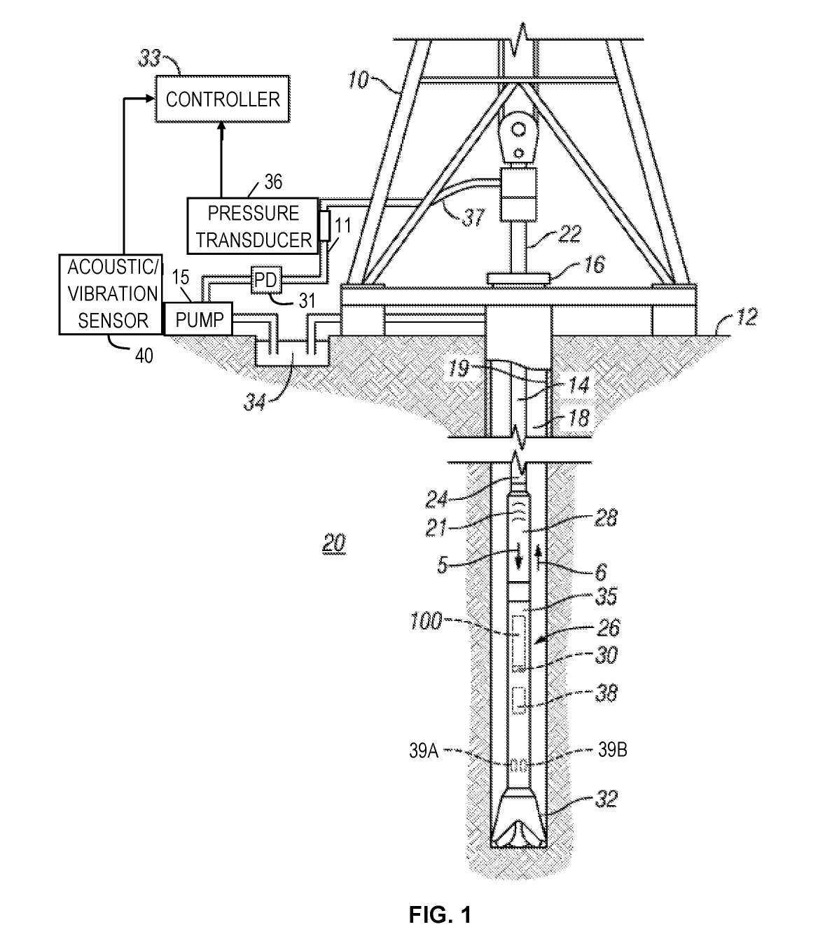

FIG. 1 depicts an illustrative MPT environment. The MPT environment includes a drilling derrick 10, constructed at the surface 12 of the well, supporting a drill string 14. The drill string 14 extends through a rotary table 16 and into a borehole 18 that is being drilled through earth formations 20. The drill string 14 may include a kelly 22 at its upper end, drill pipe 24 coupled to the kelly 22, and a BHA 26 coupled to the lower end of the drill pipe 24. The BHA 26 may include drill collars 28, a survey tool (e.g., a MWD or LWD tool) 30, and a drill bit 32 for penetrating through earth formations to create the borehole 18. In operation, the kelly 22, the drill pipe 24 and the BHA 26 may be rotated by the rotary table 16. Alternatively, or in addition to the rotation of the drill pipe 24 by the rotary table 16, the drill bit 32 may also be rotated, as will be understood by one skilled in the art, by a downhole motor such as a mud motor (not shown). The drill collars add weight to the drill bit 32 and stiffen the BHA 26, thereby enabling the BHA 26 to transmit weight to the drill bit 32 without buckling. The weight applied through the drill collars to the drill bit 32 permits the drill bit 32 to crush the underground formations.

As shown in FIG. 1, BHA 26 may include a survey tool 30, which may be part of the drill collar section 28. As the drill bit 32 operates, drilling fluid (commonly referred to as “drilling mud”) may be pumped from a mud pit 34 at the surface by pump 15 through standpipe 11 and feed pipe 37, through drill string 14, indicated by arrow 5, to the drill bit 32. The drilling mud is discharged from the drill bit 32 and functions to cool and lubricate the drill bit 32, and to carry away earth cuttings made by the drill bit 32. After flowing through the drill bit 32, the drilling fluid flows back to the surface through the annular area between the drill string 14 and the borehole wall 19, indicated by arrow 6, where it is collected and returned to the mud pit 34 for filtering. The circulating column of drilling mud flowing through the drill string 14 may also function as a medium for transmitting pressure signals 21 carrying information from the survey tool 30 to the surface. In one embodiment, a downhole data signaling unit 35 is provided as part of survey tool 30. Data signaling unit 35 may include a pulser 100 for generating pressure signals used for MPT.

Survey tool 30 may include sensors 39A and 39B, which may be coupled to appropriate data encoding circuitry, such as an encoder 38, which sequentially produces encoded digital data electrical signals representative of the measurements obtained by sensors 39A and 39B. While two sensors are shown, one skilled in the art will understand that a smaller or larger number of sensors may be used without departing from the principles of the present invention. The sensors 39A and 39B may be selected to measure downhole parameters including, but not limited to, environmental parameters, directional drilling parameters, and formation evaluation parameters. Example parameters may comprise downhole pressure, downhole temperature, the resistivity or conductivity of the drilling mud and earth formations, the density and porosity of the earth formations, as well as position and/or orientation information.

As shown, the survey tool 30 may be located proximate to the bit 32 to collect data. While some or all of the collected data may be stored by the survey tool 30, at least some of the collected data may be transmitted in the form of pressure signals by data signaling unit 35, through the drilling fluid in drill string 14. The data stream conveyed via the column of drilling fluid may be detected at the surface by a pressure transducer 36, which outputs an electrical signal representing fluid pressure in a tubular as a function of time. The signal output from pressure transducer 36 is conveyed to controller 33, which may be located proximate the rig floor. Alternatively, controller 33 may be located away from the rig floor. In one embodiment, controller 33 may be part of a portable logging vehicle or facility.

As shown in FIG. 1, the controller 33 also receives acoustic or vibration data from an acoustic sensor or vibration sensor 40 positioned on or near the pump 15. As described herein, acoustic or vibration data obtained from the acoustic sensor or vibration sensor 40 is analyzed to estimate pump noise or related parameters such as pump stroke timing information. With a pump noise estimate or related parameters derived at least in part from the acoustic or vibration data collected by the acoustic sensor or vibration sensor 40, the controller 33 is able to demodulate the data steam from the electrical signal received from the pressure transducer 36. As an example, the demodulated data stream may correspond to downhole drilling parameters and/or formation characteristics measured by sensors 39A and 39B, or survey tool 30.

The pump noise to be accounted for or filtered during the demodulation process is caused by the operation of pump 15, which is normally piston-based and causes a significant degree of pressure variation due to the action of the pistons and valves. In at least some embodiments, a pulsation dampener 31 is positioned along feed pipe 37 or standpipe 11 to attenuate the (relatively) high-frequency variation, typically with only a moderate degree of success. Downstream of the pulsation dampener 31, the pressure transducer 36 senses pressure variations in the fluid within the feed pipe 37 and generates corresponding signals. In different embodiments, the pressure transducer 36 may be directly in contact with the fluid conveyed via feed pipe 37 (e.g., the pressure transducer 36 physically responds to pressure variations in the fluid), or may be coupled to a tubular housing (e.g., the pressure transducer 36 measures dimensional changes in the feed pipe 37 resulting from pressure variations in the flow stream). In either case, the pressure transducer 36 provides a measurable reference signal (e.g. voltage, current, phase, position, etc.) that is correlated with fluid pressure as a function of time, i.e. dP(t)/dt. The correlation of the reference signal and fluid pressure may vary for different pressure transducer configurations.

In at least some embodiments, an example pressure transducer configuration employs a piezoelectric material attached to or surrounding the feed pipe 37. When the pressure of fluid conveyed via the feed pipe 37 changes, the piezoelectric material is distorted resulting in a different voltage level between two measurement points along the piezoelectric material. Another pressure transducer configuration employs an optical fiber wrapped around the feed pipe 37. When the pressure of fluid conveyed via the feed pipe 37 changes, the dimensions of feed pipe 37 changes resulting in the wrapped optical fiber being more or less strained (i.e., the overall length of the optical fiber is affected). The amount of strain or change to the optical fiber length can be measured (e.g., using interferometry to detect a phase change) and correlated with the pressure of fluid conveyed via the feed pipe 37. It should also be appreciated that multiple pressure transducers 36 may be employed at different points along the feed pipe 37. The outputs from multiple pressure transducers may be averaged or otherwise combined. For more information regarding available pressure transducer configurations, reference may be had to U.S. Pat. Pub. No. 2011/0116099A1, entitled “Apparatus and Method for Detecting Pressure Signals” and filed Mar. 16, 2008, and WO2014/025701 A1, entitled “Differential Pressure Mud Pulse Telemetry While Pumping” and filed Aug. 5, 2013.

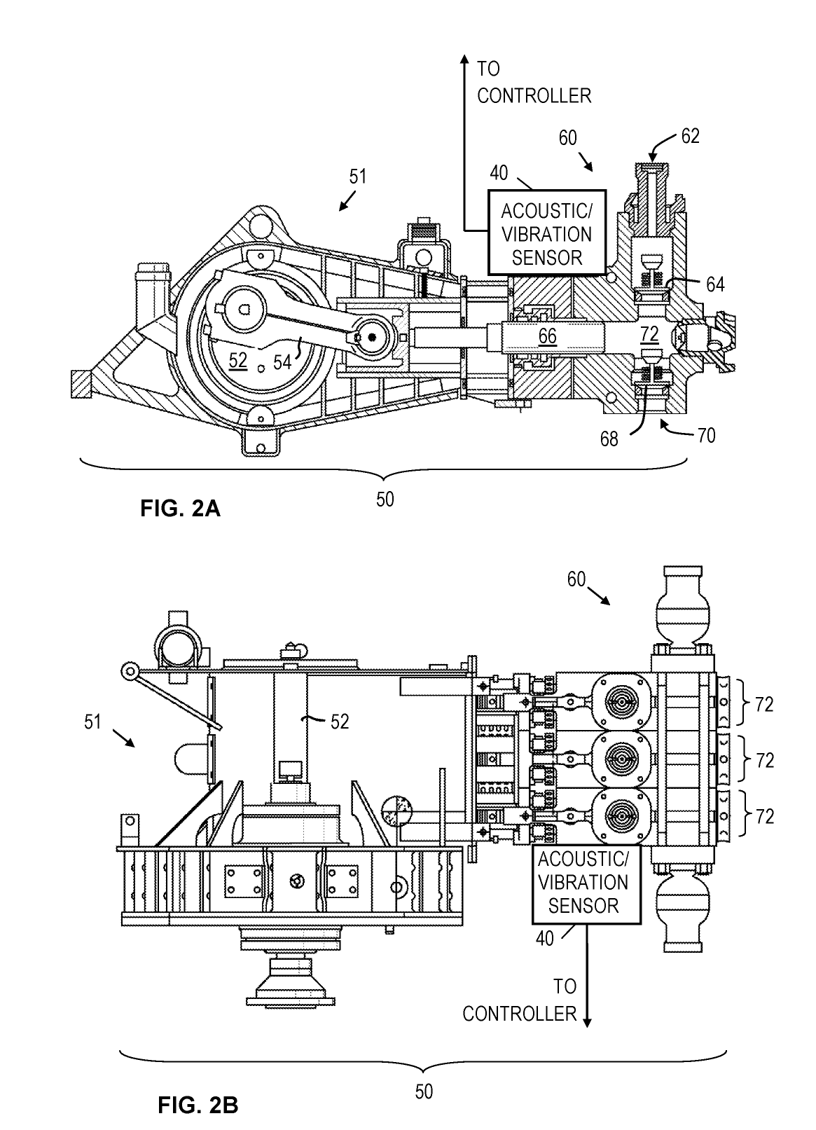

FIGS. 2A and 2B show embodiments of a positive displacement pump 50, which may correspond to pump 15. FIG. 2A is a cross-sectional view, while FIG. 2B is a top view. In FIGS. 2A and 2B, the pump 50 is described as having a fluid end 60 and a power end 51. The fluid end 60 includes an input 70, which receives fluid from a fluid source (e.g., a suction line, storage or mix tank, discharge from a boost pump such as a centrifugal pump, etc.), and an output 62, which may output fluid to a discharge source (e.g., a flow meter, distribution header, discharge line, wellhead, etc.). Further, the fluid end 60 may include a suction valve 68 for controlling the receipt of fluid through the input 70 and a discharge valve 64 for controlling the output of fluid material through the output 62. The fluid end 60 also includes a plunger 66 for controlling a pressure in a chamber 72 of the pump 50, so that fluid is suitably received into the chamber 72 via the input 70 and suction valve 68 and suitably discharged from the chamber 72 via the discharge valve 64 and the output 62. In at least some embodiments, the acoustic or vibration sensor 40 is positioned near the fluid end 60 of the pump 50 to collect acoustic or vibration data as described herein. For example, the acoustic or vibration sensor 40 may be positioned external to the pump 50 and near the plunger 66.

The power end 51 of pump 50 causes movement of the plunger 66. More specifically, the plunger 66 is coupled through a crosshead to power end components including a connecting rod 54 and a crankshaft 52. The crankshaft 52 is rotated using an engine, transmission, and drive shaft (not shown). At a rate of once per 360° rotation of the crankshaft 52, the connecting rod 54 moves the plunger 66 into and out of the chamber 72, completing a suction and discharge stroke of the pump 50.

While the view of FIG. 2A shows a single, representative chamber 72, it should be appreciated that pumps such as pump 50 may include two or more substantially identical chambers. For example, in the top view of FIG. 2B, the pump 50 is shown to include three chambers 72, where each chamber 72 has a corresponding plunger 66 connected to a common crankshaft (e.g., crankshaft 52). In such case, the movement of the plungers 66 may be aligned at 120° intervals relative to one another. In this manner, a more uniform rate of flow is possible.

During operation of pump 50, as each plunger 66 moves away from valves 64, 68 (i.e., toward the left in FIG. 2A), the pressure drop or vacuum in chamber 72 causes discharge valve 64 to close and suction valve 68 to open, allowing fluid to enter chamber 72. This phase may be known as a “suction stroke.” Meanwhile, during a “discharge stroke,” each plunger 66 moves back towards the valves 64, 68 (i.e., toward the right in FIG. 2A), forcing suction valve 68 to close and discharge valve 64 to open. Fluid may then be forced from chamber 72 through the open discharge valve 64.

Without being limited by any particular theory, when insufficient fluid enters the chamber 72 from suction valve 68, bubbles may be formed inside chamber 72 (i.e., cavitation occurs). During the discharge stroke, the presence of the bubbles causes a delay in the opening of discharge valve 64 because increased pressure is required to collapse the formed bubbles. The cavitation bubbles can inflict damage to the inner surfaces of the pump through microjets and shockwaves (e.g., pressure waves) caused by bubble collapse. The collapsing bubbles may also cause acoustic vibrations (e.g., pressure waves) in the pump chamber 72 and also cause valve bounce. The sounds and/or vibration associated with cavitation and/or valve bounce may be monitored by an acoustic sensor or vibration sensor 40 as described herein. The collected acoustic or vibration data can be analyzed to determine a pump signature, pump stroke timing information, and/or a pump noise estimate as described herein.

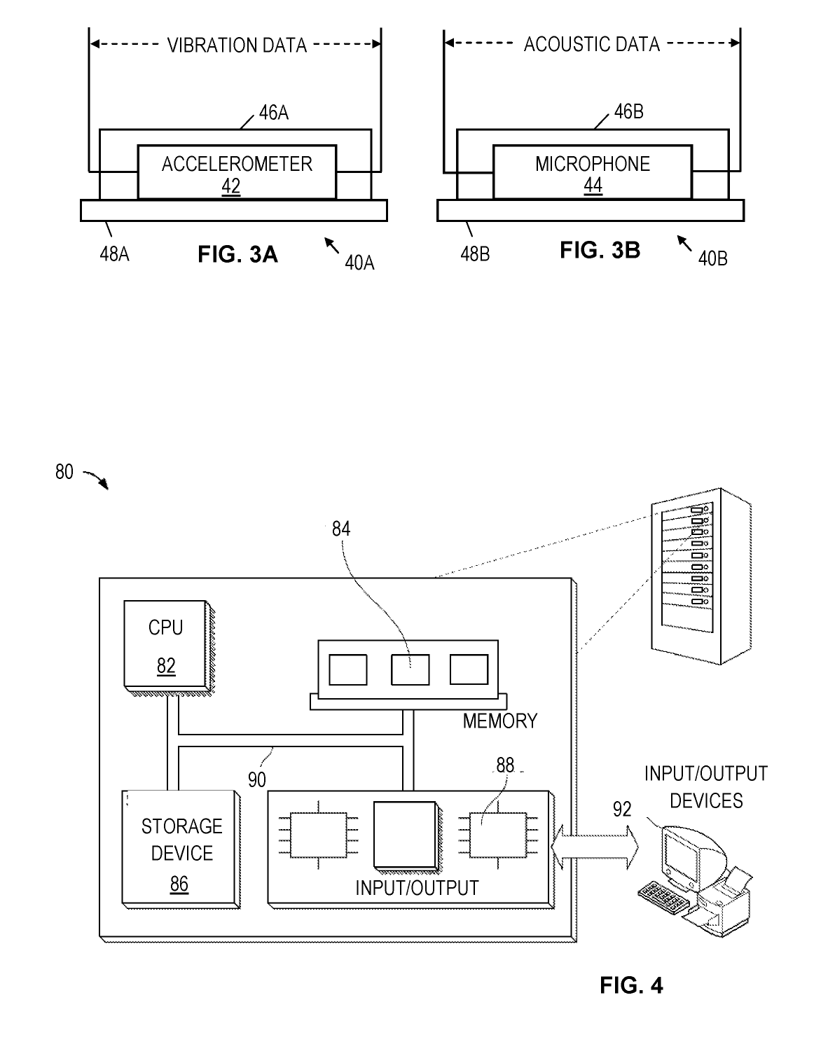

FIG. 3A shows an illustrative vibration sensor 40A. As shown, the vibration sensor 40A includes an accelerometer 42 configured to collect movement or position data as a function of time. The accelerometer 42 may correspond to a capacitive accelerometer, a piezoelectric accelerometer, a piezoresistive accelerometer, a Hall effect accelerometer, a magnetorestrictive accelerometer, a heat transfer accelerometer, a micro-electro-mechanical system (MEMS)-based accelerometer, or other commercially-available accelerometers. The vibration sensor 40A also includes a protective housing 46A around the accelerometer 42. The protective housing 46A protects the accelerometer 42 from contaminants and/or physical damage. The vibration sensor 40A also includes a base 48A below the accelerometer 42. The base 48A may form part of the protective housing 46A. In at least some embodiments, the base 48A extends past other parts of the protective housing 46A to provide one or more attachment points to facilitate attaching the vibration sensor 40A to a pump housing. Any such attachment points in the base 48A may be used with clamps, bolts, magnets, straps, adhesives, or other attachment mechanisms. The pump housing may or may not have corresponding attachment points. Further, if the protective housing 46A is sufficiently strong, a clamp or other fastener may press on one or more non-base surfaces of the protective housing 46A to fasten the vibration sensor 40A to a pump housing.

FIG. 3B shows an illustrative acoustic sensor 40B. As shown, the acoustic sensor 40B includes a microphone 44 configured to collect sound information as a function of time (acoustic data). The acoustic sensor 40B also includes a protective housing 46B around the microphone 44. The protective housing 46B protects the microphone 44 from contaminants and/or physical damage. The acoustic sensor 40B also includes a base 48B below the microphone 44. The base 48B may form part of the protective housing 46B. In at least some embodiments, the base 48B extends past other parts of the protective housing 46B to provide one or more attachment points to facilitate attaching the acoustic sensor 40B to a pump housing. Any such attachment points in the base 48B may be used with clamps, bolts, adhesives, or other attachment mechanisms. Again, the pump housing may or may not have corresponding attachment points. Further, if the protective housing 46B is sufficiently strong, a clamp or other fastener may press on one or more non-base surfaces of the protective housing 46B to fasten the acoustic sensor 40B to a pump housing. Use of microphone 44 is merely one way of collecting acoustic data. In different embodiments, the acoustic sensor 40B may employ any sensor capable of monitoring or detecting acoustic signals. In one embodiment, acoustic sensor 40B employs a commercially-available knock sensor such as Bosch® Knock Sensor model KS-P. Other sensor configurations that could be employed by acoustic sensor 40B include without limitation, sonar, photoacoustic sensors, acoustic wave sensors, or combinations thereof.

As described herein, an acoustic or vibration sensor 40 (e.g., vibration sensor 40A or acoustic sensor 40B) is employed to estimate pump noise or related parameters. Such pump noise may be related to cavitation and/or valve leakage in the pump 15. In at least some embodiments, one or more acoustic or vibration sensors 40 are mounted directly to the pump 15 (e.g., bolted, tied, or clamped to the pump housing or outer surface) or indirectly to the pump 15 (e.g., magnetically attached to a pump mount or frame). In at least some embodiments, the acoustic or vibration sensor 40 is mounted adjacent the fluid end 60 of pump 15 (e.g., where fluid enters/exists the pump) rather than the power end 51 of pump 15 (e.g., where the engine/transmission components reside). In some embodiments, one or more acoustic or vibration sensors 40 are attached directly/indirectly, adjacent/proximate to the suction and/or discharge valves on the fluid end 60 of pump 15.

In different embodiments, the acoustic or vibration sensor 40 may be configured to detect acoustic or vibration energy that is within a predetermined frequency response range. For example, an acoustic or vibration sensor 40 may have a frequency response range of from about 1 Hz to about 20,000 Hz, alternatively from about 1 Hz to about 10,000 Hz, alternatively from about 1 Hz to about 5000 Hz, alternatively from about 100 Hz to about 5000 Hz, alternatively from about 1000 Hz to about 5000 Hz. Further, in some embodiments, the acoustic or vibration sensor 40 may employ one or more filters to alter the frequency response range. Additionally or alternatively, frequency filtering operations may be performed by the controller 33

With the pump noise or related parameters estimated at least in part from acoustic or vibration data obtained by the acoustic or vibration sensor 40, the controller 33 is able to demodulate a data stream from pressure variations of fluid conveyed via a tubular and monitored by pressure transducer 36. Without limitation, the controller 33 described herein may correspond to a computing device or system such as a desktop computer, a laptop computer, a tablet computer, a smart phone, or combinations thereof having one or more data acquisition, processing, and control components in the form of software, firmware, and/or hardware. The various data acquisition, processing, and control functions described herein may be integrated into a single device, or into separate devices. The controller 33 is capable of transmitting and/or receiving data to/from various components of an MPT system.

FIG. 4 shows an illustrative computer system 80. The computer system 80 may correspond to controller 33 and/or other components involved with acoustic or vibration data analysis, MPT demodulation, data visualization, drilling or logging control, etc. The computer system 80 includes a processor 82, a memory 84, a storage device 86, and an input/output device 88. Each of the components 82, 84, 86, and 88 can be interconnected, for example, using a system bus 90. The processor 82 is capable of processing instructions for execution within the computer system 80. In some embodiments, the processor 82 is a single-threaded processor, a multi-threaded processor, or another type of processor. The processor 82 is capable of processing instructions stored in the memory 84 or on the storage device 86. The memory 84 and the storage device 86 can store information within the computer system 80.

The input/output device 88 provides input/output operations for the system 80. In some embodiments, the input/output device 88 can include one or more network interface devices, e.g., an Ethernet card; a serial communication device, e.g., an RS-232 port; and/or a wireless interface device, e.g., an 802.11 card, a 3G wireless modem, a 4G wireless modem, etc. In some embodiments, the input/output device can include driver devices configured to receive input data and send output data to other input/output devices, e.g., keyboard, printer and display devices 92. In different embodiments, the input/output devices 92 enable an operator to review or adjust acoustic or vibration data analysis options, MPT demodulation options, data visualization options, drilling or logging control options, etc.

Returning to FIG. 1, the MPT data streams to be demodulated by controller 33 as described herein can be generated by pulser 100 in different ways. For example, pulser 100 may modulate pressure to convey information using frequency modulation, phase modulation, pulse position modulation, and pulse width modulation. Other suitable modulation schemes exist. The particular modulation scheme employed by pulser 100 may be selected in accordance with criteria such as signal-to-noise ratio, attenuation, dispersion, and noise effects.

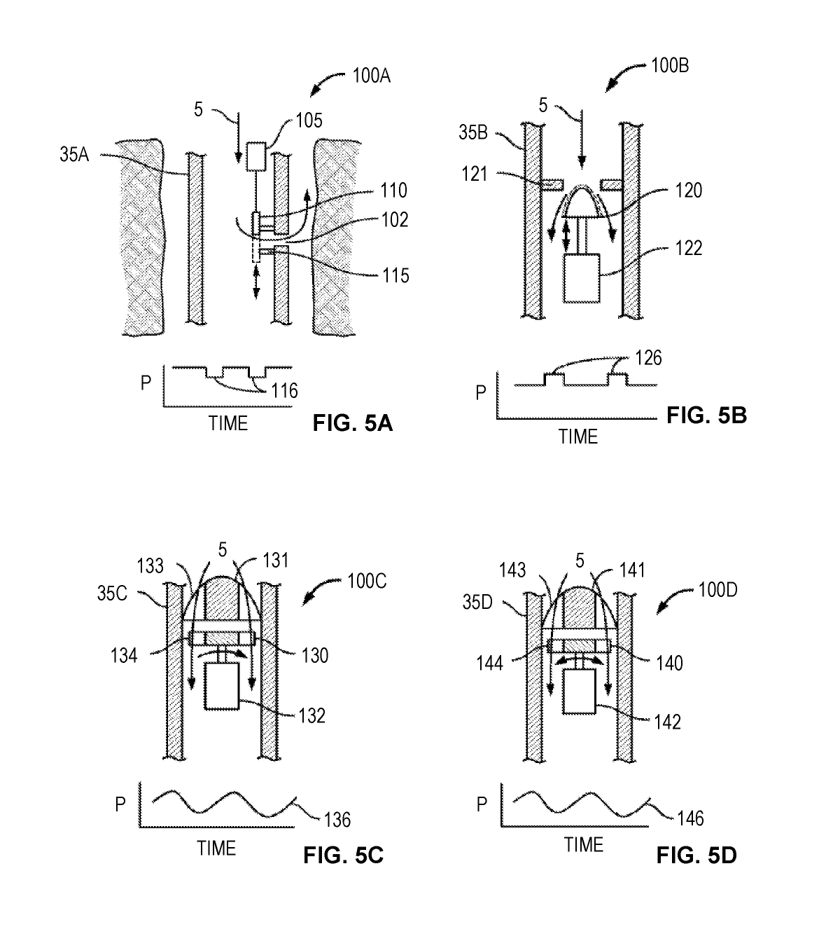

FIGS. 5A-5D show example embodiments of pulser 100. More specifically, FIG. 5A shows an illustrative negative pulser 100A, which may be part of a data signaling unit 35A. The negative pulser 100A includes a bypass valve to vent drilling fluid 5 from the interior of a drill string into the annulus, thereby bypassing the drill bit (not shown). This venting of drilling fluid 5 produces a pressure drop (i.e. a negative pressure change) within the drill string's fluid column. The bypass valve for negative pulser 100A corresponds to valve seat 115 and gate 110. The gate 110 is directed by an actuator 105 to move relative to the seat 115 to selectively open or close fluid path 102. When fluid path 102 is open, drilling fluid 5 inside the drill string is vented to the annulus such that the fluid pressure within the drill string's fluid column drops relative to a steady-state pressure that exists when the fluid path 102 is closed. After closing the fluid path 102, the fluid pressure immediately rises in the drill-string column towards the steady-state pressure. As the name suggests, opening and closing the bypass valve of negative pulser 100A creates a negative pulse that propagates throughout the column of drilling fluid 5.

FIG. 5B shows an illustrative positive pulser 100B, which may be part of a data signaling unit 35B. The positive pulser 100B has a valve corresponding to flow orifice 121 and poppet 120. The poppet 120 moves relative to the orifice 121 as directed by actuator 122 to restrict (when closed) and ease (when opened) the flow of drilling fluid 5. A closing and re-opening of the valve (also referred to as a momentary closing of the valve) generates an upgoing pressure pulse (a “positive pulse”).

FIG. 5C shows another illustrative pulser 100C, which may be part of a data signaling unit 35C. The pulser 100C has a valve or variable flow restrictor corresponding to a circular, fan-like stator 131 having multiple fan blades/fins extending radially from a central hub, and a similarly shaped rotor 130 that can spin with respect to the (stationary) stator 131 as directed by actuator 132. Regardless of the particular arrangement of fan blades/fins, stator 131 has flow passages 133 that allow drilling fluid 5 to pass therethrough. Rotor 130 also has flow passages 134. The stator 131 and rotor 130 are serially positioned within a fluid column to restrict (when closed) or ease (when open) the flow of drilling fluid 5 through the valve towards the drill-bit. More specifically, the valve of pulser 200C is in a closed position when the relative alignment of the stator and rotor fins maximally restricts fluid flow (by misaligning the openings between blades). On the other hand, the valve of pulser 200C is in an open position when the relative alignment of the stator and rotor fins minimally restricts fluid flow (by aligning the openings between blades). When the valve is closed, a pressure build up occurs within the drilling fluid 5 on the source side creating a positive pressure change that propagates up to the surface. A subsequent opening of the valve enables the upstream pressure to drop to its previous pressure. Thus as the rotor 130 spins, the valve creates a periodic pressure pulsation that is amenable to frequency and phase modulation.

FIG. 5D shows yet another illustrative pulser 100D, which may be part of a data signaling unit 35D. The pulser 100D has a valve or variable flow restrictor corresponding to a circular, fan-like stator 141 having multiple fan blades/fins extending radially from a central hub, and a similarly shaped rotor 140 that can oscillate (rather than spin as in the pulser 100C of FIG. 5C) with respect to the (stationary) stator 141 as directed by actuator 142. Regardless of the particular arrangement of fan blades/fins, stator 141 has flow passages 143 that allow drilling fluid 5 to pass therethrough. Rotor 140 also has flow passages 144. As explained for pulser 100C of FIG. 5C, the alternation between alignment and misalignment of the openings between blades/fins of stator 141 and rotor 140 produces a periodic pressure pulsation that can be frequency and phase modulated.

As part of the BHA 26, pulsers 100 (e.g., pulsers 100A-100D) may be mechanically and/or electrically coupled with sensors (e.g., sensors 39A, 39B, or survey tool 30) that measure, calculate and/or sense various conditions within or near the bottom of the borehole being drilled. The BHA 26 may have an electrical power source and inter-communicating control buses that facilitate the transfer of data between BHA components. Without limitation, the electrical power source for BHA components may correspond to batteries and/or a generator that derives power from the flow of fluids via turbine or like mechanisms. Further, control bus lines for BHA components may be of a metallic, conductive material for use with electrical systems and/or dielectric material when used with optical sources. While FIG. 1 illustrates an MPT environment with one survey tool 30 and one pulser 100, those skilled in the art will appreciate that BHA configurations may have a multitude of survey tools or sensors above and/or below a pulser and may utilize more than one telemetry technique, e.g. MPT and electromagnetic telemetry.

Downhole electronics included with the BHA 26 may collect measurements from various sensors (e.g., sensors 39A, 39B) or survey tools 30. Some example measurements may include, but are not limited to, density of rock formation, pressure of the drilling fluid, gamma ray readings, and resistivity of rock formation. Additional measurements may include, but are not limited to, direction/orientation information such as inclination, tool-face, and azimuth. As previously mentioned, the BHA 26 includes an encoder 38 (e.g., in the form of circuitry or a programmable processor executing software in an associated memory device) that encodes at least some of the measurements or derived data as a data stream for transmission by the pulser 100.

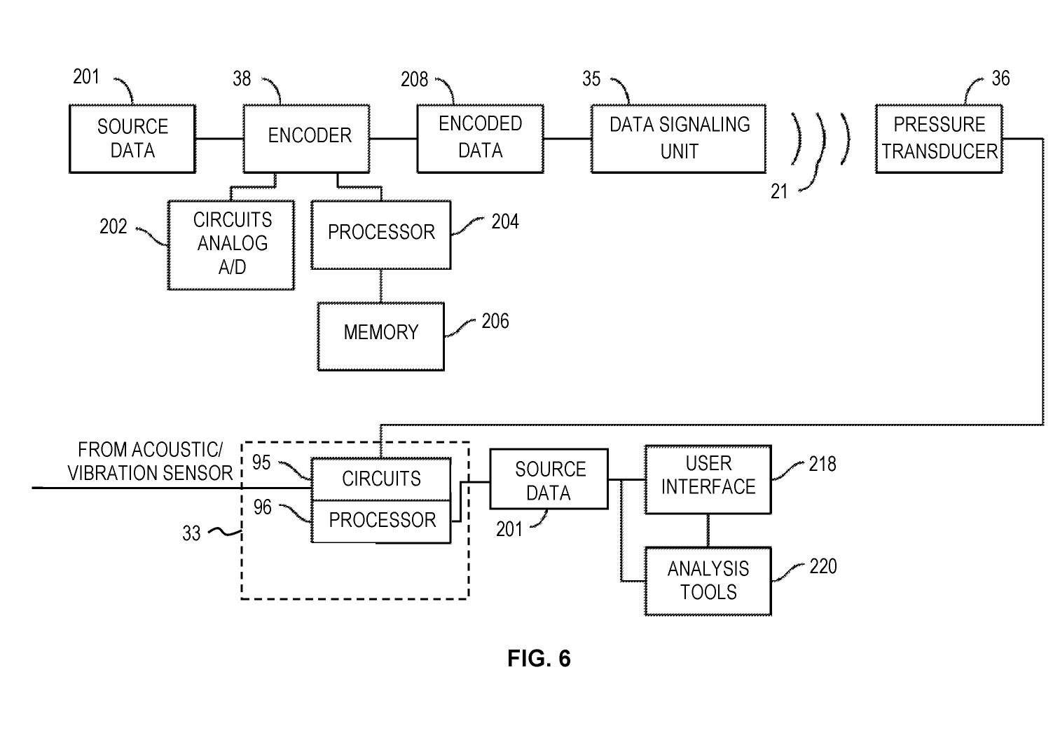

FIG. 6 is a block diagram showing an illustrative MPT process. As shown in FIG. 6, encoder 38 receives source data 201. For example, the source data 201 may correspond to measurements from sensors 39A, 39B, or survey tool 30. The source data 201 is processed as needed by dedicated circuitry 202 or a programmable processor 204 coupled to memory 206. The result of the encoding process is encoded data 208, which is forwarded to data signaling unit 35. The data signaling unit 35 converts the encoded data 208 to a modulated data stream. For example, pulser 100 of the data signaling unit 35 may transmit the modulated data stream as a series of pressure signals 21 to the surface. At earth's surface, one or more pressure transducers 36 convert the pressure signals 21 to an electrical signal or signals. The output from the one or more pressure transducers 36 are provided to controller 33, which may include circuits 95 and/or processor 96 for processing the electrical signal(s). For example, the circuits 95 may at least digitize any electrical signals received from the pressure transducer 36 as well as electrical signals received from an acoustic sensor or vibration sensor 40 as described herein.

In accordance with at least some embodiments, the processor 96 determines a pump noise estimate based at least in part on analysis of the acoustic or vibration data. Further, the processor 96 uses the pump noise estimate to demodulate the data stream encoded with the pressure signals 21. The result of the demodulation is recovery of the source data 201. Thereafter, the source data 201 or related data (e.g., logs) may be displayed via user interface 218 (e.g., input/output devices 92 of computer system 80). Further, the source data 201 may be provided to analysis tools 220 (corresponding to hardware or software processing tools) to further process the source data 201 as needed. In some embodiments, the user interface 218 and the analysis tools 220 are integrated together. The result of visualizing and/or analyzing the source data 201 or related data may be to direct drilling operations, to direct survey tool options, to perform field planning operations, and/or other operations. Such operations resulting from recovering the source data 201 may or may not involve an operator.

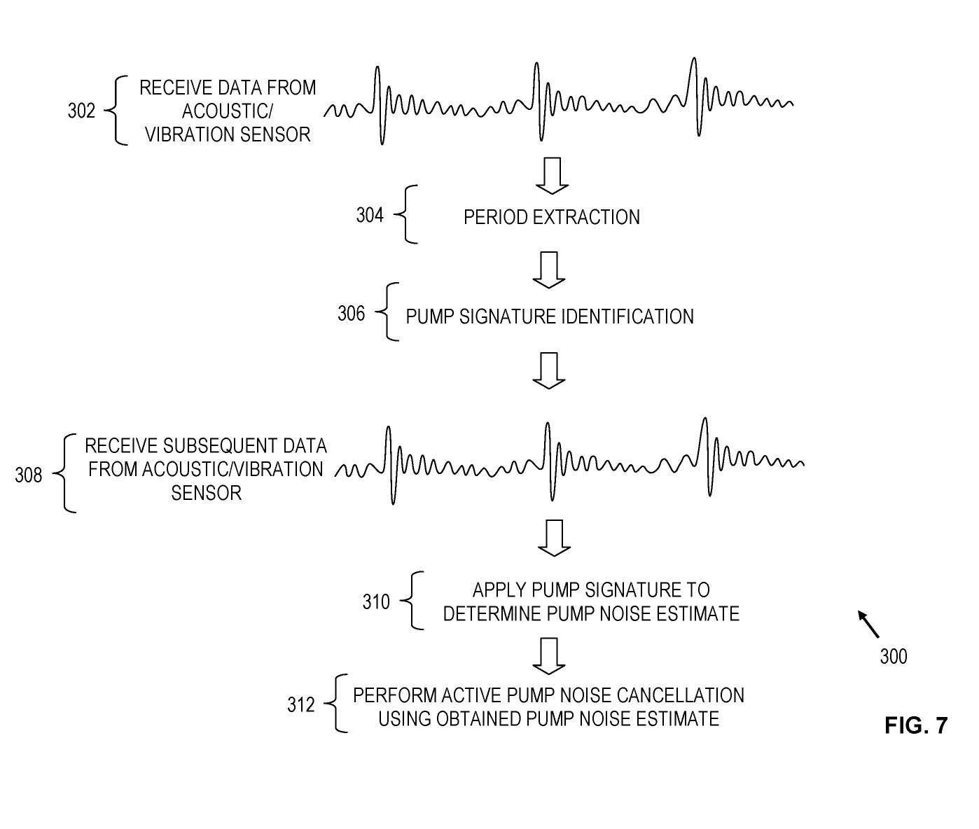

FIG. 7 shows for a process 300 obtaining and using a pump noise estimate. At block 302, data from an acoustic sensor or vibration sensor is received. As described herein, the acoustic or vibration sensor is positioned on or near a pump that pumps drilling fluid. A representative signal received at block 302 may include, for example, random noise as well as periodic features related to cavitation, valve bounce, or other phenomena that occurs during a pump's operation. At block 304, a period is extracted from the acoustic or vibration data. The period can be determined for example using time-domain signal analysis or frequency-domain signal analysis. An example time-domain signal analysis technique involves comparison of at least a portion of the signal received at block 302 with a delayed version of at least a portion of the signal. Such comparison techniques may be referred to as auto-correlation. An example frequency-domain signal analysis technique involves performing a Fast Fourier Transform (FFT) to obtain frequency information indicative of periodic patterns. At block 306, a pump signature is extracted using the period identified at block 304. The pump signature may correspond to peaks or other patterns that can be correlated with the period identified at block 304. At block 308, subsequent data is received from an acoustic sensor or vibration sensor. At bock 310, the pump signature obtained at block 306 is applied to the data obtained at block 308 to determine a pump noise estimate. At block 312, active pump noise cancellation is performed using the pump noise estimate determined at block 310. With the active pump noise cancellation of block 312, demodulation of MPT data conveyed as pressure variations of fluid in a tubular is facilitated.

The process 300 can be repeated as needed. While different embodiments may vary, modern electronics and processors are capable of performing the process 300 at a rate of at least 10 times/second. The particular timing may vary in accordance with a predetermined pump stroke timing range and/or MPT data rate. The process 300 may be combined with other techniques to perform MPT demodulation. For example, in at least some embodiments, MPT demodulation may involve sensing pressure, strain, and/or some other physical phenomenon indicative of pressure variations of fluid in a tubular to within an understood distortion. The sensing may occur at one or more points in the drilling rig's surface plumbing, such as a feed pipe downstream of a pulsation dampener. The sensed pressure variations are processed to remove at least some of a pump noise component before demodulation of the MPT data stream is performed.

Further, in at least some embodiments, analog or digital integration is employed to convert pressure variations of fluid in a tubular into an electrical signal. Further, MPT demodulation and decoding may involve equalizers, pulse detectors, edge detectors, and/or timing modules. Further, some embodiments may employ array processing of MPT signals as part of the pump noise removal and/or the equalization process.

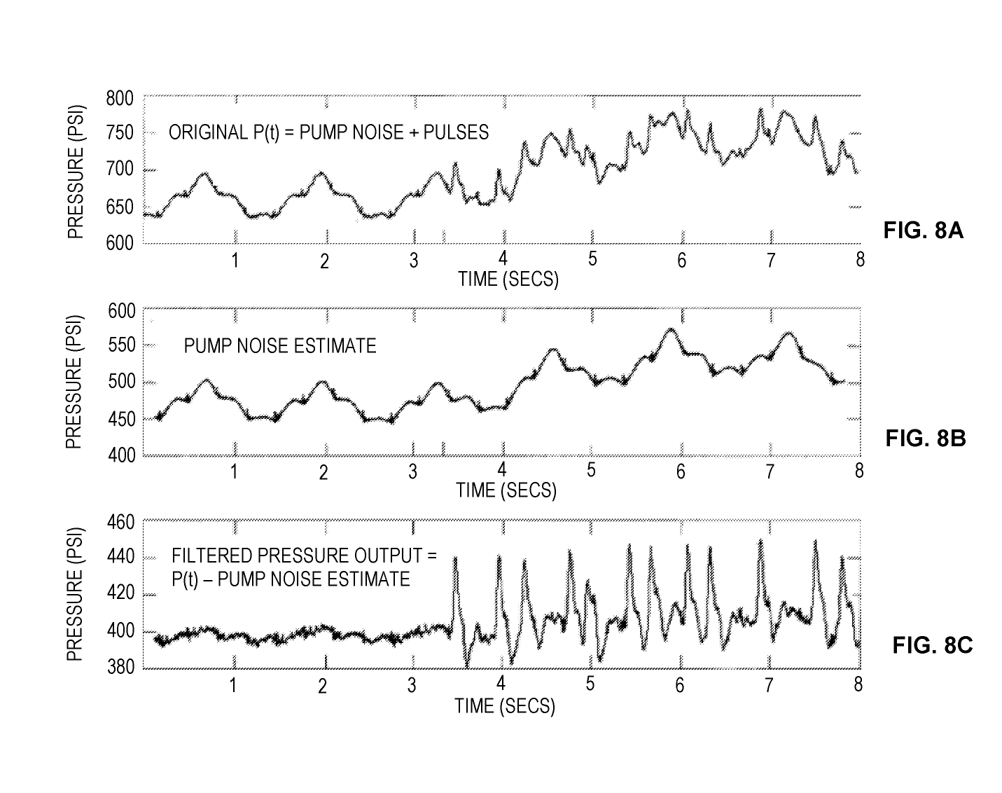

FIG. 8A-8C show illustrative graphs representing part of the MPT demodulation process. In FIG. 8A, a pressure signal, P(t), that includes pump noise and MPT data is represented. For example, P(t) may correspond to the output of pressure transducer 36. In FIG. 8B, a pump noise estimate is represented. As disclosed herein, a pump noise estimate such as the one represented in FIG. 8B can be determined at least in part from acoustic or vibration data analysis. In FIG. 8C, a filtered pressure output is represented. The filtered pressure output may correspond to, for example, the difference between P(t) in FIG. 8A and the pump noise estimate in FIG. 8B.

In accordance with at least some embodiments, controller 33 employs a pump noise filter using memory storage for holding estimates of pump signatures. As described herein, such pump signatures may be estimated from acoustic or vibration data. For example, the pump signature may correspond to acoustic or vibration patterns correlated with pump noise. The controller 33 uses the pump signatures to filter and remove at least a portion of cyclostationary pump noise, thereby yielding at the pump noise filter's output a filtered version of pressure transducer measurements (see e.g., FIG. 8C). In at least some embodiments, pump signature estimation and removal operations involve a phase lock loop to track a fundamental frequency or period of the pump noise and a current phase. In at least some embodiments, a pump stroke position is derived based on monitored acoustic or vibration data as described herein. The pump stroke position information can be used to obtain a pump noise estimate or to otherwise facilitate pump noise filtering operations.

At least some of embodiments, pump noise filtering is performed in stages. For example, a first pump noise filter may remove some of the pump noise prior to integration, while a second pump noise filter removes residual pump noise after integration. Each pump noise filter may include modules for estimating a pump noise signature at that stage of processing. While certain signals are described herein as being proportional to pressure, a time derivative, or some other physical property, those of ordinary skill in the art will recognize that this proportionality may only be true to within an understood distortion (e.g. quantization, A/D range, mean-squared-error, additive thermal noise, constant offset, known calibration function, etc.).

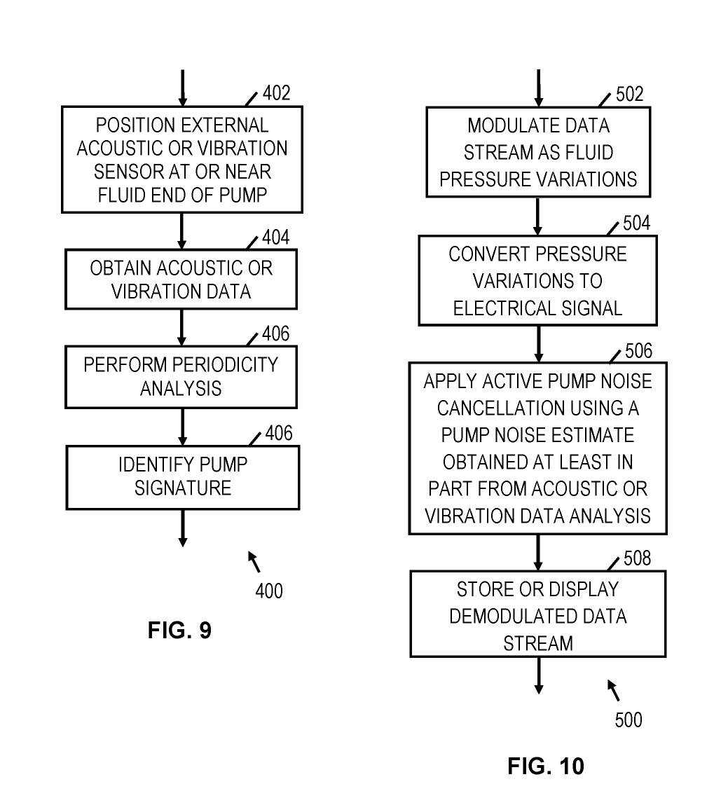

FIG. 9 is a flowchart of an illustrative acoustic or vibration data analysis method 400. The method 400 includes positioning an external acoustic or vibration sensor at or near a fluid end of a pump (e.g., fluid end 60 of pump 15) at block 402. For example, an external acoustic sensor (e.g., sensor 40B) or a vibration sensor (e.g., sensor 40A) may be mounted to a pump housing using a clamp, a band, a magnet, a strap, bolts, adhesive, and/or other attachment techniques. At block 404, acoustic or vibration data is obtained from the positioned acoustic or vibration sensor. At block 406, periodicity analysis of the acoustic or vibration data is performed. The periodicity analysis may involve time-domain signal analysis or frequency-domain signal analysis as described herein. At block 408, a pump signature is identified based on the periodicity analysis of block 406.

FIG. 10 is a flowchart showing an illustrative MPT method 500. The method 500 includes modulating a data stream as fluid pressure variations at block 502. For example, the modulation operations of block 502 may be performed by a pulser (e.g., pulsers 100A-100D) as described herein. At block 504, the pressure variations are converted to an electrical signal. For example, block 504 may be performed by one or more pressure transducers 36 as described herein. At block 506, active pump noise cancellation is applied using a pump noise estimate obtained at least in part from acoustic or vibration data analysis as described herein. In at least some embodiments, the pump noise estimate used for block 506 is obtained at least in part using a pump signature derived from acoustic or vibration data analysis (e.g., method 400). At block 508, a demodulated data stream is stored or displayed. Additionally or alternatively, logs or information derived from the demodulated data stream may be stored or displayed. Additionally or alternatively, control signals to direct drilling operations or survey tool operations may be generated based at least in part on the demodulated data stream or related data.

The methods 400 and 500 may be performed, for example, by a logging service entity. As an example scenario, the logging service entity is responsible for collecting LWD or MWD data during a drilling operation. The LWD or MWD data may be stored for later use or analysis and/or may be used to direct drilling. In the example scenario, the logging service entity does not own much of the equipment used for drilling (see FIG. 1). For example, much of the drilling equipment may be owned by a first entity and rented by a second entity. In such case, the logging service entity provides a service for the second entity and often would not have permission to modify drilling equipment (e.g., pump 15) owned by the first entity. Perhaps some of the BHA 26 could be provided by the logging service entity to facilitate logging operations. At any rate, for the example scenario, the methods 400 and 500 are non-invasive to equipment owned by the first entity, and facilitate at least some of the operations provided by the logging service entity for the second entity.

Embodiments disclosed herein include:

A: A mud pulse telemetry method that comprises positioning an external acoustic or vibration sensor on or near a pump to collect acoustic or vibration data during operation of the pump. The method also comprises monitoring a pressure of fluid in a tubular, the fluid conveying a data stream as a series of pressure variations. The method also comprises processing the monitored pressure to demodulate the data stream. The processing uses a pump noise estimate obtained at least in part from analysis of the acoustic or vibration data.

B: A mud pulse telemetry system that comprises one or more transducers that convert a pressure of fluid in a tubular to at least one electrical signal, the fluid conveying a data stream as modulated pressure variations. The system also comprises an external acoustic or vibration sensor positioned on or near a pump to collect acoustic or vibration data during operation of the pump. The system also comprises a processor that demodulates the data stream from the at least one electrical signal using a pump noise estimate obtained at least in part from analysis of the acoustic or vibration data.

Each of the embodiments, A and B, may have one or more of the following additional elements in any combination. Element 1: wherein the positioning comprises temporarily attaching the acoustic or vibration sensor to a pump housing. Element 2: wherein the positioning comprises attaching the acoustic or vibration sensor to a fluid end of the pump. Element 3: further comprising determining a periodicity of the acoustic or vibration data. Element 4: wherein determining the periodicity comprises performing time-domain signal analysis. Element 5: wherein determining the periodicity comprises performing frequency-domain signal analysis. Element 6: further comprising identifying a pump signature based at least in part on the determined periodicity. Element 7: further comprising obtaining subsequent acoustic or vibration data, applying the pump signature to the subsequent acoustic or vibration data to determine pump stroke timing information, and using the pump stroke timing information to obtain the pump noise estimate. Element 8: wherein the processing includes reducing a pump noise component of the monitored pressure based at least in part on the pump noise estimate to provide a filtered pressure signal. Element 9: further comprising deriving one or more logs from the data stream, and displaying the one or more logs. Element 10: further comprising deriving one or more commands or operating parameters from the data stream, and directing a downhole tool based at least in part on the one or more commands or operating parameters.

Element 11: wherein the acoustic or vibration sensor is temporarily attached to a pump housing. Element 12: wherein the acoustic or vibration sensor is attached to a fluid end of the pump. Element 13: wherein the processor or circuitry in communication with the processor determines a periodicity of the acoustic or vibration data. Element 14: wherein the processor or circuitry in communication with the processor determines the periodicity by performing auto-correlation of a signal corresponding to the acoustic or vibration data. Element 15: wherein the processor or circuitry in communication with the processor determines identifies a pump signature based at least in part on the determined periodicity of the acoustic or vibration data. Element 16: wherein the acoustic sensor or vibration sensor obtains subsequent acoustic or vibration data corresponding to a pump sound or vibration source, and wherein the processor applies the pump signature to the subsequent acoustic or vibration data to determine the pump noise estimate. Element 17: wherein the processor generates tool-specific data or logs from the data stream. Element 18: wherein the processor generates commands from the data stream to direct operations of a bottomhole assembly.

Numerous modifications, equivalents, and alternatives will become apparent to those skilled in the art once the above disclosure is fully appreciated. For example, the foregoing description focuses on uplink communication from the BHA to the surface, but this disclosure also applies to downlink communication from the surface to the BHA. Such downlink communications may be used to convey commands and configuration parameters to control downhole tool operations and/or steer the drill string. It is intended that the following claims be interpreted to embrace all such modifications, equivalents, and alternatives where applicable.

What is claimed is:

1. A mud pulse telemetry method that comprises:
positioning an external acoustic or vibration sensor on or near a pump to collect acoustic or vibration data during operation of the pump;
monitoring a pressure of fluid in a tubular, said fluid conveying a data stream as a series of pressure variations; and
processing the monitored pressure to demodulate the data stream, wherein said processing uses a pump noise estimate obtained at least in part from analysis of the acoustic or vibration data.

2. The method of claim 1, wherein said positioning comprises temporarily attaching the acoustic or vibration sensor to a pump housing.

3. The method of claim 1, wherein said positioning comprises attaching the acoustic or vibration sensor to a fluid end of the pump.

4. The method of claim 1, further comprising determining a periodicity of the acoustic or vibration data.

5. The method of claim 4, wherein determining the periodicity comprises performing time-domain signal analysis.

6. The method of claim 4, wherein determining the periodicity comprises performing frequency-domain signal analysis.

7. The method of claim 4, further comprising identifying a pump signature based at least in part on the determined periodicity.

8. The method of claim 7, further comprising:
obtaining subsequent acoustic or vibration data;
applying the pump signature to the subsequent acoustic or vibration data to determine pump stroke timing information; and
using the pump stroke timing information to obtain the pump noise estimate.

9. The method of claim 1, wherein said processing includes reducing a pump noise component of the monitored pressure based at least in part on the pump noise estimate to provide a filtered pressure signal.

10. The method of claim 1, further comprising:
deriving one or more logs from the data stream; and
displaying the one or more logs.

11. The method of claim 1, further comprising:
deriving one or more commands or operating parameters from the data stream; and
directing a downhole tool based at least in part on the one or more commands or operating parameters.

12. A mud pulse telemetry system that comprises:
one or more transducers that convert a pressure of fluid in a tubular to at least one electrical signal, said fluid conveying a data stream as modulated pressure variations;
an external acoustic or vibration sensor positioned on or near a pump to collect acoustic or vibration data during operation of the pump; and
a processor that demodulates the data stream from the at least one electrical signal using a pump noise estimate obtained at least in part from analysis of said acoustic or vibration data.

13. The system of claim 12, wherein the acoustic or vibration sensor is temporarily attached to a pump housing.

14. The system of claim 12, wherein the acoustic or vibration sensor is attached to a fluid end of the pump.

15. The system of claim 12, wherein the processor or circuitry in communication with the processor determines a periodicity of the acoustic or vibration data.

16. The system of claim 15, wherein the processor or circuitry in communication with the processor determines the periodicity by performing auto-correlation of a signal corresponding to the acoustic or vibration data.

17. The system of claim 16, wherein the processor or circuitry in communication with the processor determines identifies a pump signature based at least in part on the determined periodicity of the acoustic or vibration data.

18. The system of claim 17, wherein the acoustic sensor or vibration sensor obtains subsequent acoustic or vibration data corresponding to a pump sound or vibration source, and wherein the processor applies the pump signature to the subsequent acoustic or vibration data to determine the pump noise estimate.

19. The system of claim 12, wherein the processor generates tool-specific data or logs from the data stream.

20. The system of claim 12, wherein the processor generates commands from the data stream to direct operations of a bottomhole assembly.
